(19) United States
(12) Patent Application Publication
(10) Pub. No.: US 2026/0066256 A1
(43) Pub. Date: Mar. 5, 2026

(54) METHOD AND SYSTEM FOR SELF-REGULATING CONTROL OF INTERNAL CHAMBER PRESSURE OF MASS SPECTROMETER

(71) Applicant: YANTAI ZHIGONG BIOMEDICAL TECHNOLOGY CO., LTD, Yantai (CN)

(72) Inventor: Tuanjie Che, Yantai (CN)

(73) Assignee: YANTAI ZHIGONG BIOMEDICAL TECHNOLOGY CO., LTD, Yantai (CN)

(21) Appl. No.: 19/382,313

(22) Filed: Nov. 7, 2025

Related U.S. Application Data
(63) Continuation of application No. PCT/CN2025/110771, filed on Jul. 26, 2025.

(30) Foreign Application Priority Data
Sep. 3, 2024 (CN) 202411225119.9

(51) Int. Cl. H01J 49/24; H01J 49/00

(52) U.S. Cl. CPC H01J 49/24; H01J 49/0031

(57) ABSTRACT

A method and a system for self-regulating control of an internal chamber pressure of a mass spectrometer are provided. The method specifically includes: associating a first test mass spectrum set, a sample composition, a compositional ratio, and a chamber pressure regulation parameter to obtain a test data set; performing characteristic factor identification on a first real-time mass spectrum generated in real time to obtain a plurality of first real-time characteristic factors when a mass spectrometer is used for sample detection; matching the first real-time characteristic factors with different test data sets; and regulating an internal chamber pressure of the mass spectrometer according to the chamber pressure regulation parameter in the test data set when there exists a test data set with a matching degree greater than or equal to a preset value.

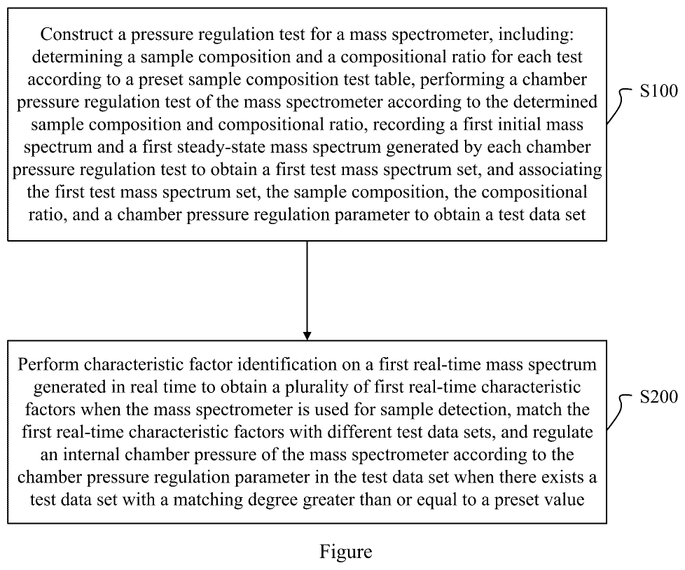

### CROSS REFERENCE TO THE RELATED APPLICATIONS

This application is a continuation application of international application no. PCT/CN2025/110771, filed on Jul. 26, 2025, which is based upon and claims priority to Chinese patent application no. 202411225119.9, filed on Sep. 3, 2024, the entire contents of which are incorporated herein by reference.

### TECHNICAL FIELD

The present disclosure relates to the technical field of mass spectrometers, and in particular to a method and system for self-regulating control of an internal chamber pressure of a mass spectrometer.

### BACKGROUND

A mass spectrometer is an instrument used for analyzing a chemical composition of a sample, and is widely applied in the fields of scientific research, environmental monitoring, biomedicine, food safety, and the like. In the mass spectrometer, the sample is ionized in an ion source, the resulting ions are then separated and detected under the actions of a magnetic field and an electric field, and a mass spectrum is generated. The accuracy and resolution of the mass spectrum directly affect the reliability of analysis results.

An internal chamber pressure of the mass spectrometer is one of important factors affecting the quality of the mass spectrum. Under different experimental conditions, such as changes in the sample composition and ratio, the chamber pressure needs to be regulated accordingly to ensure the quality of the mass spectrum. However, in the conventional mass spectrometer operation, the regulation of the chamber pressure mainly relies on the experience and intuition of an operator, and usually, desired pressure conditions may be achieved after repeated attempts and regulation operations, which is time-consuming and inefficient.

### SUMMARY

An objective of the present disclosure is to provide a method and system for self-regulating control of an internal chamber pressure of a mass spectrometer.

To achieve the above objective, the present disclosure employs the following technical solutions:

A method for self-regulating control of an internal chamber pressure of a mass spectrometer includes:
constructing a pressure regulation test for a mass spectrometer, including: determining a sample composition and a compositional ratio for each test according to a preset sample composition test table, performing a chamber pressure regulation test of the mass spectrometer according to the determined sample composition and compositional ratio, recording a first initial mass spectrum and a first steady-state mass spectrum generated by each chamber pressure regulation test to obtain a first test mass spectrum set, and associating the first test mass spectrum set, the sample composition, the compositional ratio, and a chamber pressure regulation parameter to obtain a test data set; and
performing characteristic factor identification on a first real-time mass spectrum generated in real time to obtain a plurality of first real-time characteristic factors when the mass spectrometer is used for sample detection, matching the first real-time characteristic factors with different test data sets, and regulating an internal chamber pressure of the mass spectrometer according to the chamber pressure regulation parameter in the test data set when there exists a test data set with a matching degree greater than or equal to a preset value.

In some embodiments disclosed in the present disclosure, a method for performing a chamber pressure regulation test of the mass spectrometer according to the determined sample composition and compositional ratio includes:
performing chamber pressure regulation according to a preset initial pressure regulation parameter, analyzing a first initial mass spectrum generated after the pressure regulation, and determining a correction coefficient for the initial pressure regulation parameter according to the analysis result; and
performing the chamber pressure regulation according to a corrected initial pressure regulation parameter; repeating the above chamber pressure regulation step until a first steady-state mass spectrum is obtained, where the first steady-state mass spectrum is a mass spectrum with an accuracy meeting a preset standard; and recording the pressure regulation parameter at the moment.

In some embodiments disclosed in the present disclosure, a method for analyzing a first initial mass spectrum generated after the pressure regulation includes:
determining a test position parameter, a test peak shape parameter, a test peak width parameter, and a test peak area parameter of each peak in the first initial mass spectrum to obtain a first peak characteristic parameter set;
constructing an optimal mass spectrum according to the determined sample composition and compositional ratio, and determining an optimal test position parameter, an optimal peak shape parameter, an optimal peak width parameter, and an optimal peak area parameter of each peak in the optimal mass spectrum to obtain an optimal peak characteristic parameter set;
performing a comparative analysis between the first peak characteristic parameter set and the optimal peak characteristic parameter set to obtain a first peak characteristic difference parameter set, where the first peak characteristic difference parameter set includes a first position difference vector, a first peak shape difference vector, a first peak width difference vector, and a first peak area difference vector of each peak;
calculating a position vector ratio of the first position difference vector to the test position parameter, a peak shape vector ratio of the first peak shape difference vector to the test peak shape parameter, a peak width vector ratio of the first peak width difference vector to the test peak width parameter, and a peak area vector ratio of the first peak area difference vector to the test peak area parameter for each corresponding peak; and
determining a correction coefficient for the initial pressure regulation parameter according to the position vector ratio, the peak shape vector ratio, the peak width vector ratio, and the peak area vector ratio corresponding to each peak in the first initial mass spectrum.

In some embodiments disclosed in the present disclosure, a method for determining a correction coefficient for the initial pressure regulation parameter includes:
acquiring a chamber pressure regulation record of the mass spectrometer, and determining a plurality of historical correction coefficient determination data sets according to the chamber pressure regulation record, where each of the historical correction coefficient determination data sets includes the position vector ratio, the peak shape vector ratio, the peak width vector ratio, the peak area vector ratio, the initial pressure regulation parameter, and the correction coefficient corresponding to each peak;
performing first classification on the historical correction coefficient determination data sets according to a similarity between the initial pressure regulation parameters, performing second classification on the historical correction coefficient determination data sets after the first classification according to a similarity between the peak characteristic parameters, configuring a first classification label for the first classification approach, and configuring a second classification label for the second classification approach; and
adapting the first peak characteristic parameter set to the first classification label and the second classification label to determine a plurality of corresponding historical correction coefficient determination data sets, and calculating a conformity degree between each correction coefficient determination data set and the first peak characteristic parameter, respectively;
where an expression for calculating the conformity degree is:

$$X = {X}_{max} - exp \{ {K}_{1} \times \frac{{g}_{1} + {g}_{2} - 2 g ( {g}_{1} ⋂ {g}_{2} )}{{g}_{1} + {g}_{2}} + {\sum }_{x = 1}^{4} [ {R}_{x} \times {δ}_{x} ] + {b}_{1} \} ;$$

in the formula, X represents the conformity degree, Xₘₐₓ represents a preset maximum conformity degree, K₁ represents a weight coefficient for compositional comparison, g₁ represents the number of peaks in the first initial mass spectrum, g₂ represents the number of peaks in the historical correction coefficient determination data set, g(g₁∩g₂) represents the number of peaks that correspond between the first initial mass spectrum and the historical correction coefficient determination data set, R_{X} represents a weight coefficient for a corresponding x^{th} ratio among the position vector ratio, the peak shape vector ratio, the peak width vector ratio, and the peak area vector ratio, δₓ represents a corresponding x^{th} vector ratio among the position vector ratio, the peak shape vector ratio, the peak width vector ratio, and the peak area vector ratio, and b₁ represents a conformity difference regulation constant.

In some embodiments disclosed in the present disclosure, a method for performing first classification and second classification on the historical correction coefficient determination data sets includes:
presetting an initial pressure regulation parameter table, where the initial pressure regulation parameter table includes a plurality of initial pressure regulation parameter intervals; classifying the historical correction coefficient determination data sets according to the initial pressure regulation parameter interval to which the initial pressure regulation parameter in the historical correction coefficient determination data set belongs; and identifying the corresponding initial pressure regulation parameter interval as the first classification label; and
performing a cluster analysis on the plurality of historical correction coefficient determination data sets in each category after the first classification, where a method for the cluster analysis includes setting different cluster focus weights for the position vector ratio, the peak shape vector ratio, the peak width vector ratio, and the peak area vector ratio, respectively, performing hierarchical clustering sequentially according to the cluster focus weights, recording a cluster center of each hierarchical cluster to which the historical correction coefficient determination data set belongs each time the hierarchical clustering is performed, and identifying each cluster center as the second classification label.

In some embodiments disclosed in the present disclosure, a method for performing characteristic factor identification on a first real-time mass spectrum generated in real time includes:
determining a real-time peak quantity, real-time peak vertex coordinates, and a real-time horizontal axis mapping width at a peak vertical axis median for the peaks in the first real-time mass spectrum; and setting a real-time peak quantity reference interval for the real-time peak quantity, setting a real-time peak vertex coordinate reference interval for the real-time peak vertex coordinates, and setting a real-time horizontal axis mapping width reference interval for the real-time horizontal axis mapping width;
analyzing a plurality of test data sets to determine a test peak quantity, test peak vertex coordinates, and a test horizontal axis mapping width at a peak vertical axis median for the peaks in the first initial mass spectrum or the first steady-state mass spectrum in each test data set; and selecting the first initial mass spectra or first steady-state mass spectra with the test peak quantity falling within the real-time peak quantity reference interval, the test peak vertex coordinates falling within the real-time peak vertex coordinate reference interval, and the test horizontal axis mapping width falling within the real-time horizontal axis mapping width reference interval; and
comparing the selected first initial mass spectra or first steady-state mass spectra with the first real-time mass spectrum to obtain a matching degree.

In some embodiments disclosed in the present disclosure, a method for calculating a matching degree includes:
calculating a peak quantity difference between the test peak quantity and the real-time peak quantity, and calculating a peak quantity difference reference ratio of the peak quantity difference to the test peak quantity; calculating a peak vertex-to-vertex distance between the test peak vertex coordinates and the real-time peak vertex coordinates, and calculating a peak vertex-to-vertex distance reference ratio of the peak vertex-to-vertex distance to a preset maximum peak vertex-to-vertex distance; and calculating a peak width difference between the test horizontal axis mapping width and the real-time horizontal axis mapping width, and calculating a peak width reference ratio of the peak width difference to the test horizontal axis mapping width; and
determining a matching degree between the first initial mass spectrum or the first steady-state mass spectrum and the first real-time mass spectrum according to the peak quantity difference reference ratio, the peak vertex-to-vertex distance reference ratio, and the peak width reference ratio, where the method for calculating the matching degree includes configuring difference focus weights for the peak quantity difference reference ratio, the peak vertex-to-vertex distance reference ratio, and the peak width reference ratio, respectively; calculating a difference reference degree between the first initial mass spectrum or the first steady-state mass spectrum and the first real-time mass spectrum by combining the peak quantity difference reference ratio, the peak vertex-to-vertex distance reference ratio, and the peak width reference ratio with the respective corresponding difference focus weights; and performing a subtraction operation with a preset maximum matching degree to obtain the matching degree.

In some embodiments disclosed in the present disclosure, an expression for determining a matching degree between the first initial mass spectrum or the first steady-state mass spectrum and the first real-time mass spectrum is:

$$P = {P}_{max} - exp \{ {L}_{1} \times {δ}_{1} + {L}_{2} \times {\sum }_{v = 1}^{w} [ {β}_{v} ] + {L}_{3} \times {\sum }_{v = 1}^{w} [ {γ}_{v} ] + C \} ;$$

in the formula, P represents the matching degree; βₘₐₓ represents a preset maximum matching degree; L₁ represents a first difference focus weight; L₂ represents a second difference focus weight; L₃ represents a third difference focus weight; δ₁ represents a peak quantity difference reference ratio determination function, where when the peak quantity difference reference ratio is greater than or equal to a preset value, a preset constant is outputted for δ₁; βᵥ represents a peak vertex-to-vertex distance reference ratio corresponding to a v^{th} peak; γᵥ represents a peak width reference ratio corresponding to the v^{th} peak; w represents the total number of peaks corresponding between the first initial mass spectrum or the first steady-state mass spectrum and the first real-time mass spectrum; and C represents a difference degree regulation constant.

In some embodiments disclosed in the present disclosure, a system for self-regulating control of an internal chamber pressure of a mass spectrometer is further disclosed, including:
a first module configured to construct a pressure regulation test for a mass spectrometer, including: determining a sample composition and a compositional ratio for each test according to a preset sample composition test table; performing a chamber pressure regulation test of the mass spectrometer according to the determined sample composition and compositional ratio, recording a first initial mass spectrum and a first steady-state mass spectrum generated by each chamber pressure regulation test to obtain a first test mass spectrum set, and associating the first test mass spectrum set, the sample composition, the compositional ratio, and a chamber pressure regulation parameter to obtain a test data set; and
a second module configured to perform characteristic factor identification on a first real-time mass spectrum generated in real time to obtain a plurality of first real-time characteristic factors when the mass spectrometer is used for sample detection, match the first real-time characteristic factors with different test data sets, and regulate an internal chamber pressure of the mass spectrometer according to the chamber pressure regulation parameter in the test data set when there exists a test data set with a matching degree greater than or equal to a preset value.

The present disclosure discloses a method for self-regulating control of an internal chamber pressure of a mass spectrometer and relates to the technical field of mass spectrometers. The method specifically includes: associating the first test mass spectrum set, the sample composition, the compositional ratio, and a chamber pressure regulation parameter to obtain a test data set; performing characteristic factor identification on a first real-time mass spectrum generated in real time to obtain a plurality of first real-time characteristic factors when the mass spectrometer is used for sample detection; matching the first real-time characteristic factors with different test data sets; and regulating the internal chamber pressure of the mass spectrometer according to the chamber pressure regulation parameter in the test data set when there exists a test data set with a matching degree greater than or equal to the preset value. Through the above technical solutions, the present disclosure achieves automatic determination of the chamber pressure regulation parameter, which not only enhances the operating efficiency, but also ensures the quality of the mass spectrum generated.

### BRIEF DESCRIPTION OF THE DRAWINGS

FIGURE illustrates steps of a method for self-regulating control of an internal chamber pressure of a mass spectrometer provided in an embodiment of the present disclosure.

### DETAILED DESCRIPTION OF THE EMBODIMENTS

The technical solutions in embodiments of the present disclosure will be clearly and completely described below in combination with the drawings in the embodiments of the present disclosure. It is obvious that the described embodiments are only a part of, rather than all of, the embodiments of the present disclosure.

To achieve the above objective, the present disclosure employs the following technical solutions:
With reference to FIGURE, a method for self-regulating control of an internal chamber pressure of a mass spectrometer includes:
S100, a pressure regulation test is constructed for a mass spectrometer, including: a sample composition and a compositional ratio for each test is determined according to a preset sample composition test table, a chamber pressure regulation test of the mass spectrometer is performed according to the determined sample composition and compositional ratio, a first initial mass spectrum and a first steady-state mass spectrum generated by each chamber pressure regulation test are recorded to obtain a first test mass spectrum set, and the first test mass spectrum set, the sample composition, the compositional ratio, and a chamber pressure regulation parameter are associated to obtain a test data set.

In this step, a database of ideal pressure conditions corresponding to different sample compositions and ratios is established. First, according to experimental requirements, a sample composition test table is formulated, which includes the sample compositions and ratios to be analyzed. Then, for each sample composition and ratio in the test table, a chamber pressure regulation test of the mass spectrometer is performed, which means that a pressure is regulated in an internal chamber of the mass spectrometer to identify optimal pressure conditions suitable for a specific sample. After the pressure is regulated each time, an initial mass spectrum and a mass spectrum generated after reaching a steady state are recorded to form a first test mass spectrum set. These mass spectra reflect behaviors of sample ions under different pressure conditions. Finally, the recorded test mass spectrum set is associated with the corresponding sample composition, compositional ratio, and parameter for pressure regulation to establish a test data set. This data set serves as a basis for subsequent automatic pressure regulation.

The above technical solution may be understood by the following example:
A mass spectrometer is applied in the field of environmental detection, and particularly in an analysis of volatile organic compounds (VOCs) in the air. The VOCs are a class of organic compounds that are volatile at room temperature. The VOCs exist in the air, and sources thereof include industrial emissions, vehicle exhaust, indoor decorating materials, and the like. Concentrations of these compounds have a direct impact on air quality, thus necessitating accurate detection.

A specific implementation method is as follows:

A pressure regulation test is constructed:
First, a sample composition test table is formulated according to various VOC compositions and ratios that may exist in environmental detection.

Then, for each VOC composition and ratio, a chamber pressure regulation test of the mass spectrometer is performed. During each test, a chamber pressure is regulated, and an initial mass spectrum and a mass spectrum generated after reaching a steady state are recorded to form a first test mass spectrum set.

Finally, the recorded test mass spectrum set is associated with the corresponding VOC composition, compositional ratio, and parameter for pressure regulation to establish a test data set.

Characteristic factor identification of real-time mass spectra and automatic pressure regulation are as follows:
During actual detection of an ambient air sample, the mass spectrometer is configured to generate mass spectra in real time.

A system is configured to analyze these real-time mass spectra and identify characteristic factors thereof, such as the number, positions, shapes, and areas of peaks.

The identified characteristic factors are matched with the pre-established test data set to identify a most similar VOC composition and ratio.

When a test data set with a matching degree greater than or equal to a preset value is identified, the system automatically regulates the internal chamber pressure of the mass spectrometer according to a pressure regulation parameter recorded in the data set.

In this way, the mass spectrometer is capable of automatically optimizing the internal chamber pressure during environmental detection, thereby improving detection accuracy and repeatability, and consequently providing more reliable data support for environmental monitoring.

In some embodiments disclosed in the present disclosure, a method for performing a chamber pressure regulation test of the mass spectrometer according to the determined sample composition and compositional ratio includes:
S101, chamber pressure regulation is performed according to a preset initial pressure regulation parameter, a first initial mass spectrum generated after the pressure regulation is analyzed, and a correction coefficient for the initial pressure regulation parameter is determined according to the analysis result.

In some embodiments disclosed in the present disclosure, a method for analyzing a first initial mass spectrum generated after the pressure regulation includes:
S1011, a test position parameter, a test peak shape parameter, a test peak width parameter, and a test peak area parameter of each peak in the first initial mass spectrum are determined to obtain a first peak characteristic parameter set.
S1012, an optimal mass spectrum is constructed according to the determined sample composition and compositional ratio, and an optimal test position parameter, an optimal peak shape parameter, an optimal peak width parameter, and an optimal peak area parameter of each peak in the optimal mass spectrum are determined to obtain an optimal peak characteristic parameter set.

In this step, a method for determining an optimal mass spectrum includes:
(1) A reference substance is selected or designed: A reference substance with a known composition and ratio is selected, or a standard mixture is designed and synthesized to ensure that the composition and ratio of the sample match experimental requirements. (2) Ion generation and transmission characteristics are determined: The ionization efficiency of each component of the sample in the mass spectrometer and the transmission characteristics of ions in the mass spectrometer, including collision, scattering, and focusing effects, are predicted according to known chemical reactions and ionization techniques. (3) A theoretical fragmentation pattern is calculated: Expected fragment ions are calculated according to a chemical structure and possible fragmentation pathways of each molecule. (4) A mass spectrum is simulated: A theoretical mass spectrum is simulated using mass spectrometry simulation software according to the above information; and the simulated mass spectrum displays all expected ion peaks, including retention time, an intensity, and possible isotopic distribution. (5) Parameters are optimized: Simulation parameters, such as collision energy, ion transmission efficiency, and settings of a mass analyzer, are regulated according to a specific model and configuration of the mass spectrometer to optimize the theoretical mass spectrum. (6) An optimal peak characteristic parameter set is constructed: Characteristic parameters of each peak, such as a peak position (an m/z value), a peak shape, a peak width, and a peak area, are extracted from the simulated mass spectrum, and these parameters constitute an optimal peak characteristic parameter set.

Further, a method for calculating a theoretical fragmentation pattern includes: formation of molecular ions (parent ions): First, molecules in the sample are ionized in an ion source, typically by methods such as electron impact (EI), electrospray ionization (ESI), atmospheric pressure chemical ionization (APCI), or matrix-assisted laser desorption/ionization (MALDI). In this process, molecules lose one or more electrons to form positively charged molecular ions. Prediction of the fragmentation pattern: The molecular ions further undergo fragmentation in the mass spectrometer to generate a series of fragment ions. These fragments result from breakage of chemical bonds in the molecular ions, which may involve breakage of a single bond or consecutive breakage of a plurality of bonds.

Prediction of the fragmentation pattern involves a bond energy: Different types of chemical bonds (such as C—C, C—H, and C—O) have different bond energies, and these bond energies determine which bonds are prone to breakage during ionization. Stability and charge distribution: Stability and charge distribution of the fragment ions affect fragment formation, and positive charges usually stabilize certain parts of the molecules, thereby affecting the fragmentation pathways. Mass spectrometry fragmentation rules: Certain types of compounds tend to produce specific fragmentation patterns, and these rules may be obtained through literature research or database queries.

Calculation methods: The theoretical fragmentation pattern may be calculated using different methods, including: empirical rules, where possible fragments generated from the molecular ions are predicted according to known mass spectrometry fragmentation rules and empirical knowledge; computer-aided calculations, where specialized software tools, such as Mass Frontier or MM2, are employed to calculate all possible fragment ions according to a molecular structure and an ionization mode; and quantum chemical calculations, where a more advanced method involves using quantum chemistry software, such as Gaussian, to perform molecular orbital calculations, and predict a lowest energy path during fragmentation, so as to determine the most probable fragment ions.
S1013, a comparative analysis is performed between the first peak characteristic parameter set and the optimal peak characteristic parameter set to obtain a first peak characteristic difference parameter set, where the first peak characteristic difference parameter set includes a first position difference vector, a first peak shape difference vector, a first peak width difference vector, and a first peak area difference vector of each peak.
S1014, a position vector ratio of the first position difference vector to the test position parameter, a peak shape vector ratio of the first peak shape difference vector to the test peak shape parameter, a peak width vector ratio of the first peak width difference vector to the test peak width parameter, and a peak area vector ratio of the first peak area difference vector to the test peak area parameter is calculated for each corresponding peak.
S1015, a correction coefficient for the initial pressure regulation parameter is determined according to the position vector ratio, the peak shape vector ratio, the peak width vector ratio, and the peak area vector ratio corresponding to each peak in the first initial mass spectrum.

In some embodiments disclosed in the present disclosure, a method for determining a correction coefficient for the initial pressure regulation parameter includes:
S10151, a chamber pressure regulation record of the mass spectrometer is acquired, and a plurality of historical correction coefficient determination data sets are determined according to the chamber pressure regulation record, where each of the historical correction coefficient determination data sets includes the position vector ratio, the peak shape vector ratio, the peak width vector ratio, the peak area vector ratio, the initial pressure regulation parameter, and the correction coefficient corresponding to each peak.
S10152, first classification is performed on the historical correction coefficient determination data sets according to a similarity between the initial pressure regulation parameters, second classification is performed on the historical correction coefficient determination data sets after the first classification according to a similarity between the peak characteristic parameters, a first classification label is configured for the first classification approach, and a second classification label is configured for the second classification approach.
S10153, the first peak characteristic parameter set is adapted to the first classification label and the second classification label to determine a plurality of corresponding historical correction coefficient determination data sets, and a conformity degree between each correction coefficient determination data set and the first peak characteristic parameter is calculated, respectively;
where an expression for calculating the conformity degree is:

$$X = {X}_{max} - exp \{ {K}_{1} \times \frac{{g}_{1} + {g}_{2} - 2 g ( {g}_{1} ⋂ {g}_{2} )}{{g}_{1} + {g}_{2}} + {\sum }_{x = 1}^{4} [ {R}_{x} \times {δ}_{x} ] + {b}_{1} \} ;$$

in the formula, X represents the conformity degree, Xₘₐₓ represents a preset maximum conformity degree, K₁ represents a weight coefficient for compositional comparison, g₁ represents the number of peaks in the first initial mass spectrum, g₂ represents the number of peaks in the historical correction coefficient determination data set, g(g₁∩g₂) represents the number of peaks that correspond between the first initial mass spectrum and the historical correction coefficient determination data set, Rₓ represents a weight coefficient for a corresponding x^{th} ratio among the position vector ratio, the peak shape vector ratio, the peak width vector ratio, and the peak area vector ratio, δₓ represents a corresponding x^{th} vector ratio among the position vector ratio, the peak shape vector ratio, the peak width vector ratio, and the peak area vector ratio, and b₁ represents a conformity difference regulation constant.

In some embodiments disclosed in the present disclosure, a method for performing first classification and second classification on the historical correction coefficient determination data sets includes:
S101521, an initial pressure regulation parameter table is preset, where the initial pressure regulation parameter table includes a plurality of initial pressure regulation parameter intervals; the historical correction coefficient determination data sets is classified according to the initial pressure regulation parameter interval to which the initial pressure regulation parameter in the historical correction coefficient determination data set belongs; and the corresponding initial pressure regulation parameter interval is identified as the first classification label.
S101522, a cluster analysis is performed on the plurality of historical correction coefficient determination data sets in each category after the first classification, where a method for the cluster analysis includes setting different cluster focus weights for the position vector ratio, the peak shape vector ratio, the peak width vector ratio, and the peak area vector ratio, respectively, performing hierarchical clustering sequentially according to the cluster focus weights, recording a cluster center of each hierarchical cluster to which the historical correction coefficient determination data set belongs each time the hierarchical clustering is performed, and identifying each cluster center as the second classification label.
S102, the chamber pressure regulation is performed according to a corrected initial pressure regulation parameter; the above chamber pressure regulation step is repeated until the first steady-state mass spectrum is obtained, where the first steady-state mass spectrum is a mass spectrum with an accuracy meeting a preset standard; and the pressure regulation parameter at the moment is recorded.
S200, characteristic factor identification is performed on a first real-time mass spectrum generated in real time to obtain a plurality of first real-time characteristic factors when the mass spectrometer is used for sample detection, the first real-time characteristic factors are matched with different test data sets, and the internal chamber pressure of the mass spectrometer is regulated according to the chamber pressure regulation parameter in the test data set when there exists a test data set with a matching degree greater than or equal to the preset value.

In this step, the system is configured to analyze these real-time mass spectra and identify characteristic factors thereof, which may include the number, positions, shapes, and areas of peaks; then, the identified characteristic factors are matched with the pre-established test data set to identify a most similar sample composition and ratio; this step is implemented by comparing the real-time mass spectrum with the test mass spectrum set; and when the test data set with a matching degree greater than or equal to the preset value is identified, the system automatically regulates the internal chamber pressure of the mass spectrometer according to the pressure regulation parameter recorded in the data set, which ensures that the chamber pressure of the mass spectrometer is consistently maintained in an optimal state during actual detection, thereby enhancing the accuracy and repeatability of the detection.

In some embodiments disclosed in the present disclosure, a method for performing characteristic factor identification on a first real-time mass spectrum generated in real time includes:
S201, a real-time peak quantity, real-time peak vertex coordinates, and a real-time horizontal axis mapping width at a peak vertical axis median are determined for the peaks in the first real-time mass spectrum; and a real-time peak quantity reference interval is set for the real-time peak quantity, a real-time peak vertex coordinate reference interval is set for the real-time peak vertex coordinates, and a real-time horizontal axis mapping width reference interval is set for the real-time horizontal axis mapping width.
S202, a plurality of test data sets are analyzed to determine a test peak quantity, test peak vertex coordinates, and a test horizontal axis mapping width at a peak vertical axis median for the peaks in the first initial mass spectrum or the first steady-state mass spectrum in each test data set; and the first initial mass spectra or first steady-state mass spectra with the test peak quantity falling within the real-time peak quantity reference interval, the test peak vertex coordinates falling within the real-time peak vertex coordinate reference interval, and the test horizontal axis mapping width falling within the real-time horizontal axis mapping width reference interval are selected.
S203, the selected first initial mass spectra or first steady-state mass spectra are compared with the first real-time mass spectrum to obtain a matching degree.

In some embodiments disclosed in the present disclosure, a method for calculating a matching degree includes:
S2031, a peak quantity difference between the test peak quantity and the real-time peak quantity is calculated, and a peak quantity difference reference ratio of the peak quantity difference to the test peak quantity is calculated; a peak vertex-to-vertex distance between the test peak vertex coordinates and the real-time peak vertex coordinates is calculated, and a peak vertex-to-vertex distance reference ratio of the peak vertex-to-vertex distance to a preset maximum peak vertex-to-vertex distance is calculated; and a peak width difference between the test horizontal axis mapping width and the real-time horizontal axis mapping width is calculated, and a peak width reference ratio of the peak width difference to the test horizontal axis mapping width is calculated.
S2032, a matching degree between the first initial mass spectrum or the first steady-state mass spectrum and the first real-time mass spectrum is determined according to the peak quantity difference reference ratio, the peak vertex-to-vertex distance reference ratio, and the peak width reference ratio, where the method for calculating the matching degree includes configuring difference focus weights for the peak quantity difference reference ratio, the peak vertex-to-vertex distance reference ratio, and the peak width reference ratio, respectively; calculating a difference reference degree between the first initial mass spectrum or the first steady-state mass spectrum and the first real-time mass spectrum by combining the peak quantity difference reference ratio, the peak vertex-to-vertex distance reference ratio, and the peak width reference ratio with the respective corresponding difference focus weights; and performing a subtraction operation with a preset maximum matching degree to obtain the matching degree.

In some embodiments disclosed in the present disclosure, an expression for determining a matching degree between the first initial mass spectrum or the first steady-state mass spectrum and the first real-time mass spectrum is:

$$P = {P}_{max} - exp \{ {L}_{1} \times {δ}_{1} + {L}_{2} \times {\sum }_{v = 1}^{w} [ {β}_{v} ] + {L}_{3} \times {\sum }_{v = 1}^{w} [ {γ}_{v} ] + C \} ;$$

in the formula, P represents the matching degree; βₘₐₓ represents a preset maximum matching degree; L₁ represents a first difference focus weight; L₂ represents a second difference focus weight; L₃ represents a third difference focus weight; δ₁ represents a peak quantity difference reference ratio determination function, where when the peak quantity difference reference ratio is greater than or equal to a preset value, a preset constant is outputted for δ₁; δᵥ represents a peak vertex-to-vertex distance reference ratio corresponding to a v^{th} peak; γᵥ represents a peak width reference ratio corresponding to the v^{th} peak; w represents the total number of peaks corresponding between the first initial mass spectrum or the first steady-state mass spectrum and the first real-time mass spectrum; and C represents a difference degree regulation constant.

In some embodiments disclosed in the present disclosure, a system for self-regulating control of an internal chamber pressure of a mass spectrometer is further disclosed, including:
a first module configured to construct a pressure regulation test for a mass spectrometer, including: determining a sample composition and a compositional ratio for each test according to a preset sample composition test table, performing a chamber pressure regulation test of the mass spectrometer according to the determined sample composition and compositional ratio, recording a first initial mass spectrum and a first steady-state mass spectrum generated by each chamber pressure regulation test to obtain a first test mass spectrum set, and associating the first test mass spectrum set, the sample composition, the compositional ratio, and a chamber pressure regulation parameter to obtain a test data set; and
a second module configured to perform characteristic factor identification on a first real-time mass spectrum generated in real time to obtain a plurality of first real-time characteristic factors when the mass spectrometer is used for sample detection, match the first real-time characteristic factors with different test data sets, and regulate the internal chamber pressure of the mass spectrometer according to the chamber pressure regulation parameter in the test data set when there exists a test data set with a matching degree greater than or equal to a preset value.

The present disclosure discloses a method for self-regulating control of an internal chamber pressure of a mass spectrometer and relates to the technical field of mass spectrometers. The method specifically includes: associating the first test mass spectrum set, the sample composition, the compositional ratio, and a chamber pressure regulation parameter to obtain a test data set; performing characteristic factor identification on a first real-time mass spectrum generated in real time to obtain a plurality of first real-time characteristic factors when the mass spectrometer is used for sample detection; matching the first real-time characteristic factors with different test data sets; and regulating the internal chamber pressure of the mass spectrometer according to the chamber pressure regulation parameter in the test data set when there exists a test data set with a matching degree greater than or equal to the preset value. Through the above technical solutions, the present disclosure achieves automatic determination of the chamber pressure regulation parameter, which not only enhances the operating efficiency, but also ensures the quality of the mass spectrum generated.

The above descriptions are only preferred embodiments of the present disclosure, but the protection scope of the present disclosure is not limited thereto. Any equivalent substitutions or modifications made by those skilled in the art within the technical scope disclosed in the present disclosure according to the technical solutions and inventive concepts of the present disclosure should fall within the protection scope of the present disclosure.

What is claimed is:

1. A method for self-regulating control of an internal chamber pressure of a mass spectrometer, comprising:
constructing a pressure regulation test for the mass spectrometer, comprising: determining a sample composition and a compositional ratio for each test according to a preset sample composition test table, performing a chamber pressure regulation test of the mass spectrometer according to the sample composition and the compositional ratio, recording a first initial mass spectrum and a first steady-state mass spectrum generated by each chamber pressure regulation test to obtain a first test mass spectrum set, and associating the first test mass spectrum set, the sample composition, the compositional ratio, and a chamber pressure regulation parameter to obtain a test data set; and
performing characteristic factor identification on a first real-time mass spectrum generated in real time to obtain a plurality of first real-time characteristic factors when the mass spectrometer is used for sample detection, matching the plurality of first real-time characteristic factors with different test data sets, and regulating the internal chamber pressure of the mass spectrometer according to the chamber pressure regulation parameter in the test data set when a test data set with a matching degree greater than or equal to a first preset value exists.

2. The method for the self-regulating control of the internal chamber pressure of the mass spectrometer according to claim 1, wherein a method for performing the chamber pressure regulation test of the mass spectrometer according to the sample composition and the compositional ratio comprises:
performing chamber pressure regulation according to a preset initial pressure regulation parameter, analyzing the first initial mass spectrum generated after the chamber pressure regulation, and determining a correction coefficient for an initial pressure regulation parameter according to an analysis result; and
performing the chamber pressure regulation according to a corrected initial pressure regulation parameter; repeating the above chamber pressure regulation step until the first steady-state mass spectrum is obtained, wherein the first steady-state mass spectrum is a mass spectrum with an accuracy meeting a preset standard; and recording a pressure regulation parameter when the first steady-state mass spectrum is obtained.

3. The method for the self-regulating control of the internal chamber pressure of the mass spectrometer according to claim 2, wherein a method for analyzing the first initial mass spectrum generated after the chamber pressure regulation comprises:
determining a test position parameter, a test peak shape parameter, a test peak width parameter, and a test peak area parameter of each peak in the first initial mass spectrum to obtain a first peak characteristic parameter set;
constructing an optimal mass spectrum according to the sample composition and the compositional ratio, and determining an optimal test position parameter, an optimal peak shape parameter, an optimal peak width parameter, and an optimal peak area parameter of each peak in the optimal mass spectrum to obtain an optimal peak characteristic parameter set;
performing a comparative analysis between the first peak characteristic parameter set and the optimal peak characteristic parameter set to obtain a first peak characteristic difference parameter set, wherein the first peak characteristic difference parameter set comprises a first position difference vector, a first peak shape difference vector, a first peak width difference vector, and a first peak area difference vector of each peak;
calculating a position vector ratio of the first position difference vector to the test position parameter, a peak shape vector ratio of the first peak shape difference vector to the test peak shape parameter, a peak width vector ratio of the first peak width difference vector to the test peak width parameter, and a peak area vector ratio of the first peak area difference vector to the test peak area parameter for each corresponding peak; and
determining the correction coefficient for the initial pressure regulation parameter according to the position vector ratio, the peak shape vector ratio, the peak width vector ratio, and the peak area vector ratio corresponding to each peak in the first initial mass spectrum.

4. The method for the self-regulating control of the internal chamber pressure of the mass spectrometer according to claim 3, wherein a method for determining the correction coefficient for the initial pressure regulation parameter comprises:
acquiring a chamber pressure regulation record of the mass spectrometer, and determining a plurality of historical correction coefficient determination data sets according to the chamber pressure regulation record, wherein each of the plurality of historical correction coefficient determination data sets comprises the position vector ratio, the peak shape vector ratio, the peak width vector ratio, the peak area vector ratio, the initial pressure regulation parameter, and the correction coefficient corresponding to each peak;
performing first classification on the plurality of historical correction coefficient determination data sets according to a similarity between initial pressure regulation parameters, performing second classification on the plurality of historical correction coefficient determination data sets after the first classification according to a similarity between peak characteristic parameters, configuring a first classification label for a first classification approach, and configuring a second classification label for a second classification approach; and
adapting the first peak characteristic parameter set to the first classification label and the second classification label to determine a plurality of corresponding historical correction coefficient determination data sets, and calculating a conformity degree between each correction coefficient determination data set and a first peak characteristic parameter, respectively;
wherein an expression for calculating the conformity degree is:
$$X = {X}_{max} - exp \{ {K}_{1} \times \frac{{g}_{1} + {g}_{2} - 2 g ( {g}_{1} ⋂ {g}_{2} )}{{g}_{1} + {g}_{2}} + {\sum }_{x = 1}^{4} [ {R}_{x} \times {δ}_{x} ] + {b}_{1} \} ;$$
in the expression, X represents the conformity degree, Xₘₐₓ represents a preset maximum conformity degree, K₁ represents a weight coefficient for compositional comparison, g₁ represents a number of peaks in the first initial mass spectrum, g₂ represents a number of peaks in a historical correction coefficient determination data set, g(g₁∩g₂) represents a number of peaks that correspond between the first initial mass spectrum and the historical correction coefficient determination data set, R_{X} represents a weight coefficient for a corresponding x^{th} ratio among the position vector ratio, the peak shape vector ratio, the peak width vector ratio, and the peak area vector ratio, δₓ represents a corresponding x^{th} vector ratio among the position vector ratio, the peak shape vector ratio, the peak width vector ratio, and the peak area vector ratio, and b₁ represents a conformity difference regulation constant.

5. The method for the self-regulating control of the internal chamber pressure of the mass spectrometer according to claim 4, wherein a method for performing the first classification and the second classification on the plurality of historical correction coefficient determination data sets comprises:
presetting an initial pressure regulation parameter table, wherein the initial pressure regulation parameter table comprises a plurality of initial pressure regulation parameter intervals; classifying the plurality of historical correction coefficient determination data sets according to an initial pressure regulation parameter interval, wherein the initial pressure regulation parameter in the historical correction coefficient determination data set belongs to the initial pressure regulation parameter interval; and identifying a corresponding initial pressure regulation parameter interval as the first classification label; and
performing a cluster analysis on the plurality of historical correction coefficient determination data sets in each category after the first classification, wherein a method for the cluster analysis comprises setting different cluster focus weights for the position vector ratio, the peak shape vector ratio, the peak width vector ratio, and the peak area vector ratio, respectively, performing hierarchical clustering sequentially according to the different cluster focus weights, recording a cluster center of each hierarchical cluster, wherein the historical correction coefficient determination data set belongs to the cluster center of each hierarchical cluster each time the hierarchical clustering is performed, and identifying each cluster center as the second classification label.

6. The method for the self-regulating control of the internal chamber pressure of the mass spectrometer according to claim 1, wherein a method for performing the characteristic factor identification on the first real-time mass spectrum generated in real time comprises:
determining a real-time peak quantity, real-time peak vertex coordinates, and a real-time horizontal axis mapping width at a peak vertical axis median for peaks in the first real-time mass spectrum; and setting a real-time peak quantity reference interval for the real-time peak quantity, setting a real-time peak vertex coordinate reference interval for the real-time peak vertex coordinates, and setting a real-time horizontal axis mapping width reference interval for the real-time horizontal axis mapping width;
analyzing a plurality of test data sets to determine a test peak quantity, test peak vertex coordinates, and a test horizontal axis mapping width at a peak vertical axis median for peaks in the first initial mass spectrum or the first steady-state mass spectrum in each of the plurality of test data sets; and selecting first initial mass spectra or first steady-state mass spectra with the test peak quantity falling within the real-time peak quantity reference interval, the test peak vertex coordinates falling within the real-time peak vertex coordinate reference interval, and the test horizontal axis mapping width falling within the real-time horizontal axis mapping width reference interval; and
comparing the first initial mass spectra or the first steady-state mass spectra with the first real-time mass spectrum to obtain a matching degree.

7. The method for the self-regulating control of the internal chamber pressure of the mass spectrometer according to claim 6, wherein a method for calculating the matching degree comprises:
calculating a peak quantity difference between the test peak quantity and the real-time peak quantity, and calculating a peak quantity difference reference ratio of the peak quantity difference to the test peak quantity; calculating a peak vertex-to-vertex distance between the test peak vertex coordinates and the real-time peak vertex coordinates, and calculating a peak vertex-to-vertex distance reference ratio of the peak vertex-to-vertex distance to a preset maximum peak vertex-to-vertex distance; and calculating a peak width difference between the test horizontal axis mapping width and the real-time horizontal axis mapping width, and calculating a peak width reference ratio of the peak width difference to the test horizontal axis mapping width; and
determining a matching degree between the first initial mass spectrum or the first steady-state mass spectrum and the first real-time mass spectrum according to the peak quantity difference reference ratio, the peak vertex-to-vertex distance reference ratio, and the peak width reference ratio, wherein the method for calculating the matching degree comprises configuring difference focus weights for the peak quantity difference reference ratio, the peak vertex-to-vertex distance reference ratio, and the peak width reference ratio, respectively; calculating a difference reference degree between the first initial mass spectrum or the first steady-state mass spectrum and the first real-time mass spectrum by combining the peak quantity difference reference ratio, the peak vertex-to-vertex distance reference ratio, and the peak width reference ratio with respective corresponding difference focus weights; and performing a subtraction operation with a preset maximum matching degree to obtain the matching degree.

8. The method for the self-regulating control of the internal chamber pressure of the mass spectrometer according to claim 7, wherein an expression for determining the matching degree between the first initial mass spectrum or the first steady-state mass spectrum and the first real-time mass spectrum is:
$$P = {P}_{max} - exp \{ {L}_{1} \times {δ}_{1} + {L}_{2} \times {\sum }_{v = 1}^{w} [ {β}_{v} ] + {L}_{3} \times {\sum }_{v = 1}^{w} [ {γ}_{v} ] + C \} ;$$
in the expression, P represents the matching degree; βₘₐₓ represents the preset maximum matching degree; L₁ represents a first difference focus weight; L₂ represents a second difference focus weight; L₃ represents a third difference focus weight; δ₁ represents a peak quantity difference reference ratio determination function, wherein when the peak quantity difference reference ratio is greater than or equal to a second preset value, a preset constant is outputted for δ₁; βᵥ represents a peak vertex-to-vertex distance reference ratio corresponding to a v^{th} peak; γᵥ represents a peak width reference ratio corresponding to the v^{th} peak; w represents a total number of peaks corresponding between the first initial mass spectrum or the first steady-state mass spectrum and the first real-time mass spectrum; and C represents a difference degree regulation constant.

9. A system for self-regulating control of an internal chamber pressure of a mass spectrometer, comprising:
a first module configured to construct a pressure regulation test for the mass spectrometer, comprising: determining a sample composition and a compositional ratio for each test according to a preset sample composition test table, performing a chamber pressure regulation test of the mass spectrometer according to the sample composition and the compositional ratio, recording a first initial mass spectrum and a first steady-state mass spectrum generated by each chamber pressure regulation test to obtain a first test mass spectrum set, and associating the first test mass spectrum set, the sample composition, the compositional ratio, and a chamber pressure regulation parameter to obtain a test data set; and
a second module configured to perform characteristic factor identification on a first real-time mass spectrum generated in real time to obtain a plurality of first real-time characteristic factors when the mass spectrometer is used for sample detection, match the plurality of first real-time characteristic factors with different test data sets, and regulate the internal chamber pressure of the mass spectrometer according to the chamber pressure regulation parameter in the test data set when a test data set with a matching degree greater than or equal to a preset value exists.
